(19) United States
(12) Patent Application Publication
(10) Pub. No.: US 2022/0074801 A1
(43) Pub. Date: Mar. 10, 2022

(54) MAGNETIC SHIELDING OF A TORQUE SENSOR FOR AN ELECTROMECHANICAL POWER STEERING SYSTEM IN A MOTOR VEHICLE

(71) Applicants: thyssenkrupp Presta AG, Eschen (LI); thyssenkrupp AG, Essen (DE)

(72) Inventors: Roman AYER, Buchs (CH); Michael DONA, Ludesch (AT); Peter KNOLL, Lindau (DE)

(73) Assignees: thyssenkrupp Presta AG, Eschen (LI); thyssenkrupp AG, Essen (DE)

(21) Appl. No.: 17/299,105

(22) PCT Filed: Dec. 10, 2019
(86) PCT No.: PCT/EP2019/084383

§ 371 Date: Jun. 2, 2021

(30) Foreign Application Priority Data
Dec. 11, 2018 (DE) 10 2018 131 712.3

(51) Int. Cl. G01L 3/10; G01L 5/22; B62D 6/10

(52) U.S. Cl. CPC G01L 3/104; B62D 6/10; G01L 5/221

(57) ABSTRACT

A torque sensor unit includes a ring magnet that is connectable to a first partial shaft in a torque-proof manner, a magnetic yoke that is connectable to a second partial shaft and that is arranged in a magnetic field of the ring magnet, magnetic flux conductors that are connectable to the second partial shaft and that conduct magnetic fluxes generated by the magnetic yoke, a sensor unit having a first housing, which detects a change in rotational angle between the partial shafts by measuring magnetic flux density generated between the magnetic flux conductors, and a second housing that surrounds the ring magnet, the magnetic yoke, the magnetic flux conductors, and the sensor unit. The second housing may include a housing opening that is at least partly closed by a housing cover. The second housing and the housing cover may comprise magnetically conductive material for magnetically shielding the torque sensor unit.

The present invention relates to a torque sensor unit having the features of the preamble of claim 1 and to an electromechanical power steering system for a motor vehicle having such a torque sensor unit.

Torque sensors are used in a motor vehicle to measure the torque introduced into the steering wheel by a driver. Torque sensors currently used are magnetic sensors, the measurement of which can very easily be disrupted by external magnetic fields. In the future and already to a certain extent currently, motor vehicles will be completely or partially electrically operated, which can lead to high external field-influencing measurements through high current-carrying cables, which are frequently located in the vicinity of the steering system.

The prior art discloses a series of torque sensors which have magnetic shielding.

Document U.S. Pat. No. 7,021,161 B2 discloses a steering angle sensor which has a first gear wheel which is connected to an upper steering shaft and which is in engagement with a second, smaller gear wheel, wherein the smaller gear wheel is surrounded by a shield, which has a cutout for the first gear wheel. The shield delimits the magnetic field of the sensor of the second gear wheel.

Published documents EP 3 276 317 A1, EP 3 276 318 A1 and EP 3 239 678 A1 disclose torque sensor units having a magnetic shield that is C-shaped in cross section and which circumferentially surrounds magnetic flux conductors arranged on the lower steering shaft.

It is an object of the present invention to specify a torque sensor unit which has a reduced influence by an existing external magnetic interference field on the determination of the torque value and, associated therewith, has an increased accuracy.

This object is achieved by a torque sensor unit having the features of claim 1 and by an electromechanical power steering system for a motor vehicle having such a torque sensor unit. Advantageous developments emerge from the subordinate claims.

Accordingly, the invention provides a torque sensor unit comprising:

a ring magnet which can be connected to a first partial shaft in a torque-proof manner,

at least one magnetic yoke which can be connected to a second partial shaft and which is arranged in a magnetic field originating from the ring magnet,

at least two magnetic flux conductors which can be connected to the second partial shaft and which conduct the magnetic fluxes generated by the at least one magnetic yoke,

a sensor unit having a first housing, which detects a change in rotational angle between the partial shafts by measuring the magnetic flux density generated between the magnetic flux conductors,

a second housing, which surrounds the ring magnet, the at least one magnetic yoke, the at least two magnetic flux conductors and the sensor unit and which has a housing opening which is at least partly closed by a housing cover, wherein the second housing and the housing cover are made of a magnetically conductive material for the magnetic shielding of the torque sensor unit.

Since the entire torque sensor unit is surrounded by the housing, it can be protected against disruptive external magnetic fields.

Preferably, the housing cover has a cutout, through which the first partial shaft passes when installed and in which an inner casing tube is accommodated, wherein the inner casing tube is likewise made of a magnetically conductive material for the magnetic shielding of the torque sensor unit. The shielding thus extends all around the torque sensor unit and is sealed off magnetically.

The inner casing tube is preferably part of an adjustable steering column. Preferably, the inner casing tube is welded to the housing cover.

In a preferred embodiment, the soft magnetic material of the shielding has a high magnetic conductivity and a low coercivity, in particular ferritic steel.

In a preferred embodiment, the sensor unit comprises at least one magnetic flux conductor and a magnetic sensor arranged on a circuit board, which are accommodated in a first housing. It is also possible to provide for the sensor unit to function with a step-down transmission, on the Nonius principle. Preferably, the housing cover is fixed by means of screws to an outer wall of the second housing. The sensor housing (first housing) is likewise preferably fixed by means of screws in the interior of the second housing, to a base plate of the second housing.

In an advantageous embodiment, the second housing has a housing opening in the area of the sensor element for a data line and/or a power supply to be led through to be fixed to the sensor element.

A flange for fixing the second housing to a transmission housing can be attached to a side of the base plate of the second housing that is remote from the opening.

Furthermore, an electromechanical steering system for a motor vehicle is provided, comprising a steering pinion which is connected to a second partial shaft and which is in engagement with a rack for steering wheels, wherein the rack is mounted such that it can be displaced along a longitudinal axis in a third housing, at least one electric motor for steering force assistance, a previously described torque sensor unit, which is arranged between a first partial shaft connected to the steering wheel and the second partial shaft and detects a torque introduced into the steering wheel by the driver. This results in the aforementioned advantages.

Preferably, a steering column comprising the first partial shaft and the second partial shaft is telescopic, wherein the steering column has an outer casing tube and the inner casing tube.

In a preferred embodiment, the electric motor is arranged on the steering column and introduces power steering assistance into the lower partial shaft by means of a transmission arranged in the transmission housing.

In the following, an exemplary embodiment of the present invention will be described by using the drawings. Identical components or components having identical functions have the same reference signs. In the drawings:

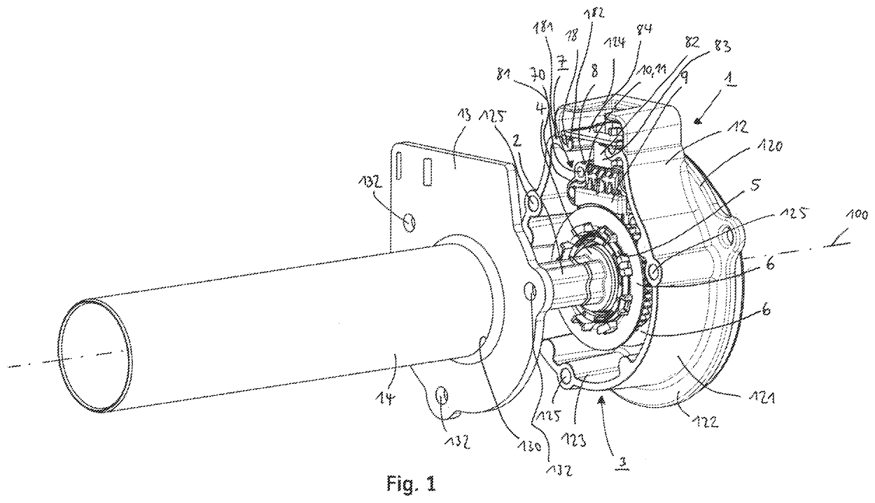

FIG. 1: shows a three-dimensional view of a torque sensor unit and of a steering angle sensor with a sensor housing,

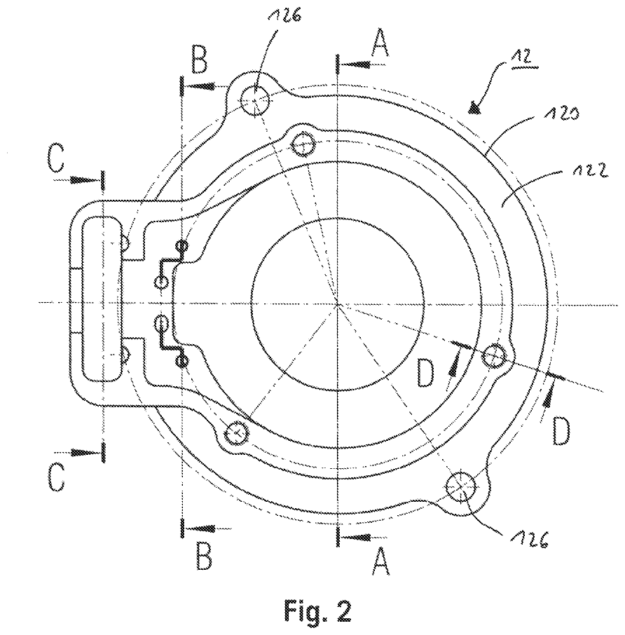

FIG. 2: shows a plan view of a front face of the housing of the torque sensor unit,

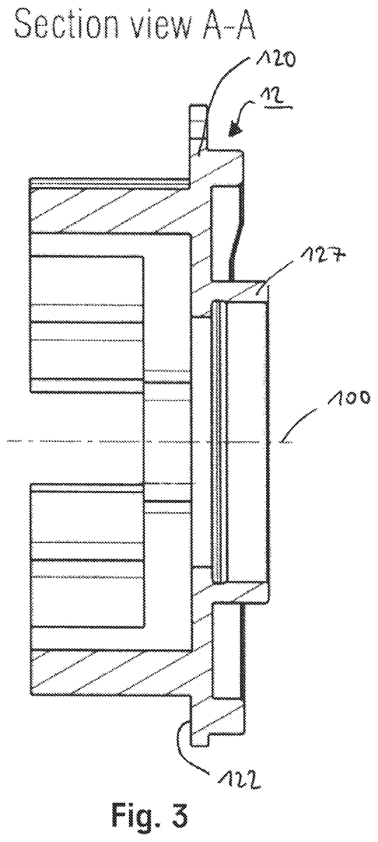

FIG. 3: shows a section through the housing of the torque sensor unit illustrated in FIG. 2, along the line A-A,

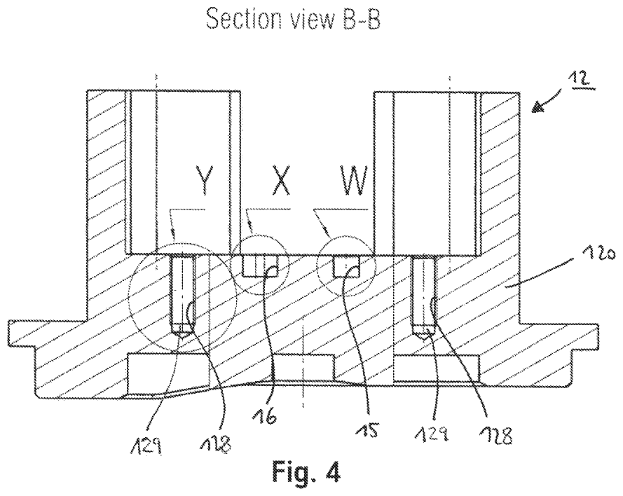

FIG. 4: shows a section through the housing of the torque sensor unit illustrated in FIG. 2, along the line B-B,

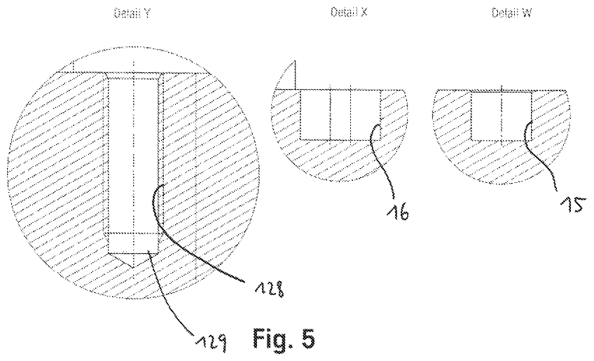

FIG. 5: shows three detailed views of the areas Y, X, W illustrated in FIG. 4,

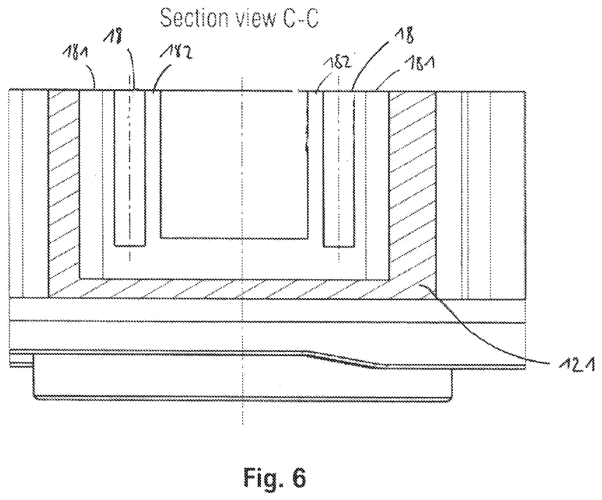

FIG. 6: shows a section through the housing of the torque sensor unit illustrated in FIG. 2, along the line C-C,

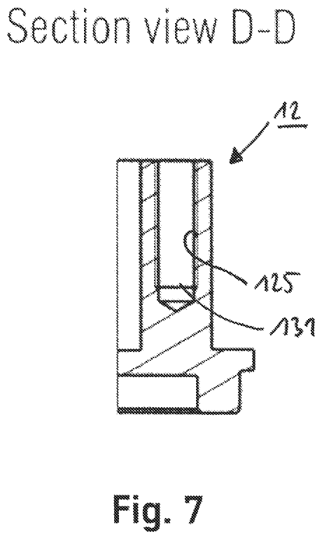

FIG. 7: shows a section through the housing of the torque sensor unit illustrated in FIG. 2, along the line D-D,

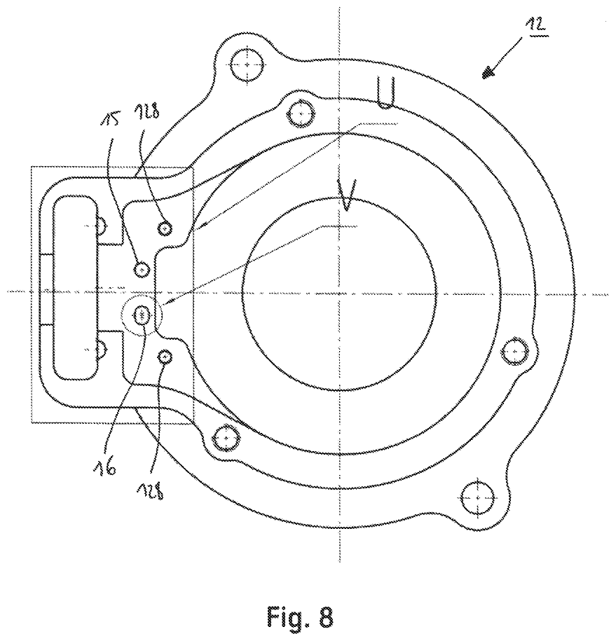

FIG. 8: shows a further plan view of the front face of the housing of the torque sensor unit,

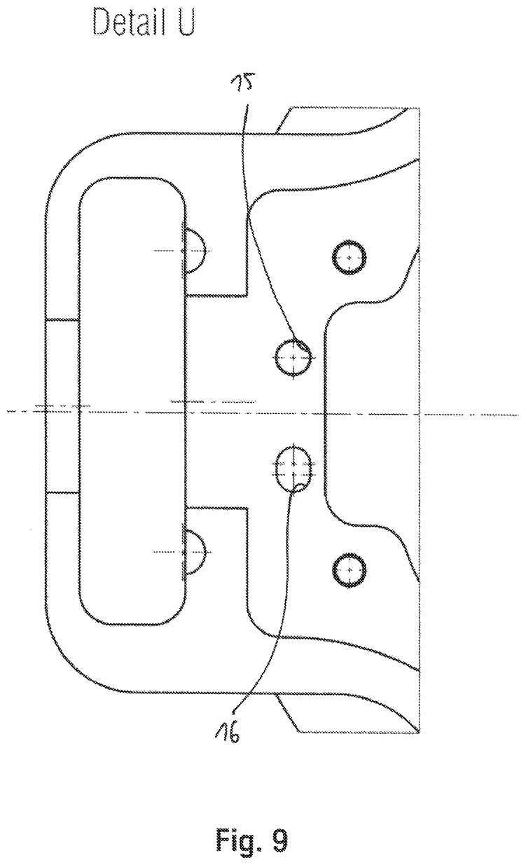

FIG. 9: shows a detail view of the area U illustrated in FIG. 8, and

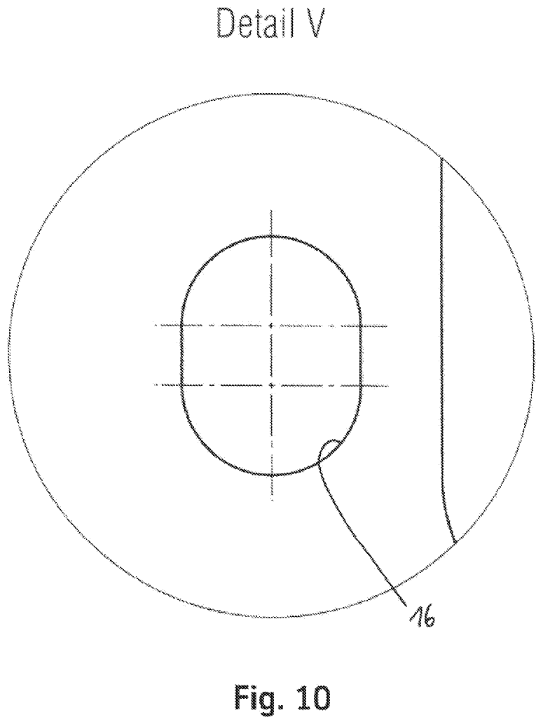

FIG. 10: shows a detail view of the area V illustrated in FIG. 8.

FIG. 1 illustrates a torque sensor unit 1, which measures a rotation of an upper steering shaft 2 relative to a lower steering shaft, not illustrated, as a measure of the torque exerted manually by a driver on the upper steering shaft 2 or a steering wheel connected to the upper steering shaft 2. The upper steering shaft 2 and the lower steering shaft are rotatably coupled to each other in a torsionally elastic manner via a torsion rod, not shown. A torque sensor unit 1 has a rotational angle sensor, which is also designated as a torque sensor. Depending on the torque measured by the torque sensor unit 1, a servo unit provides steering assistance for the driver.

The torque sensor unit 1 is part of an integral assembly which comprises a steering angle sensor unit 3. The steering angle sensor unit 3 measures the current steering angle of the lower steering shaft.

The torque sensor unit 1 has a ring magnet (permanent magnet) 4 connected to the upper steering shaft 2 in a torque-proof manner and having a multiplicity of poles. A set of magnetic yokes 5, which is fixed to the lower steering shaft, is arranged in a magnetic field generated by the four-pole magnet 4. Each of the magnetic yokes 5 is produced from a soft magnetic material and has a plurality of claw poles, which are arranged equidistantly in the circumferential direction. Magnetic yokes 5 are arranged such that their claw poles interengage. The four-pole magnet 4 and the assembled yokes 5 are arranged such that the center of each claw pole of the magnetic yokes 5 coincides with a magnetic boundary line (i.e. a boundary between an N pole and an S pole) in order to obtain a neutral point at which the output signal (the output voltage) from the magnetic field sensor becomes zero if the torsion rod is not twisted (i.e. when no steering force is transmitted between the upper steering shaft and the lower steering shaft).

A set of magnetic flux conductors 6 conducts and “gathers” the magnetic fluxes generated by the magnetic yokes 5. A physically fixed sensor unit 7 detects the magnetic flux density generated in an air gap between the magnetic flux conductors 6 located opposite each other in the axial direction.

The sensor unit 7 has a first housing 8 and, arranged therein, a magnetic flux conductor 9 and a magnetic sensor 11 arranged on a circuit board 10. The flux conductors 6, 9 are used to concentrate the magnetic flux on the magnetic sensor 11. The magnetic sensor 11 detects the rotation of the upper steering shaft 2 connected to the magnetic ring 4 with respect to the lower steering shaft connected to the magnetic yokes 5 and the magnetic flux conductors 6. During installation, the first housing 8 of the sensor unit 7 is inserted into a second housing 12 of the torque sensor unit 1.

When installed, the second housing 12 of the torque sensor unit surrounds the ring magnet 4, the set of magnetic yokes 5, the flux conductors 6 and the sensor unit 7. The second housing 12 of the torque sensor unit has a base surface 120 which functions as a base and onto which an outer wall 121 which serves as an edge and which is arranged substantially perpendicularly on the base 120 is placed. The outer wall 121 is preferably welded onto the base 120. In an area outside the sensor element 7, the base 120 projects outwardly to the outer wall 121, so that a ledge 122 is formed there on the outer side of the outer wall 121. The outer wall 121 encloses the entire torque sensor unit 1 circumferentially. On the side remote from the base, the second housing 12 has an opening 123. This opening 123 opens the housing 12 toward the upper steering shaft 2. The opening 123 is covered by a housing cover 13. The housing cover 13 has a cutout 130, through which the upper steering shaft 2 passes when installed. The housing cover 13 is connected, preferably welded, to an inner casing tube 14 of a steering column. The inner casing tube 14 is inserted into the cutout 130. The inner casing tube 14 is part of an adjustable steering column. It is surrounded by an outer casing tube, not illustrated, and the two casing tubes are designed to be telescopic relative to each other.

The second housing 12 has a housing opening 124 in the edge 121 in the area of the sensor element 7. The sensor element 7 can be connected to a data line and to a power supply through the housing opening 124.

The housing cover 13 is screwed firmly to the second housing 12 by means of screws 131, as illustrated in FIG. 7. For this purpose, in the area of the outer wall 121 the second housing 12 has a threaded hole 125, which extend parallel to a longitudinal axis 100 of the torque sensor unit 1. The threaded holes 125 are preferably distributed uniformly along the circumference. The housing cover 13 has cutouts 132 which correspond to the threaded holes 125 and through which the screws 131 to be screwed into the threaded holes 125 pass.

Details of the second housing 12 are illustrated in FIGS. 2 to 10. As is illustrated in FIGS. 2 and 3, the base 120 has two further threaded holes 126 in the area of the ledge 122 for fixing the second housing 12 to a transmission housing, not illustrated. Beside the further threaded holes 126, a flange 127 is provided to form a connection to the transmission housing, not illustrated. The second housing 12 functions as a housing cover for the transmission housing.

The sensor housing 8 is likewise fixed to the second housing 12 by means of screws 129. As is illustrated in FIG. 4 and in detail in FIG. 5, the housing base 120 of the second housing 12 has threaded holes 128. The connecting screws 129 pass through the holes 70, illustrated in FIG. 1, on the sensor housing 7, in order then to engage in the threaded holes 129 in the housing base 120. In addition, two positioning holes 15, 16 are also provided in the housing base 120. Both the positioning holes 15, 16 and the threaded holes 29 extend parallel to the housing longitudinal axis 100. In FIGS. 8 to 10, the positioning holes 15, 16 are illustrated in detail. One of the holes 16 is oval in cross section, and the second hole 15 is circular in cross section. Positioning pins, which are attached to a rear side of the sensor housing 8, engage in the two positioning holes 15, 16.

The sensor unit 7 is surrounded by the first housing 8, which has a first area 81 in which the flux conductor 9, the circuit board 10 and the magnetic sensor 11 are accommodated. This first area 81 of the first housing 8 is closed by a housing cover, not illustrated, when assembled. In a second area 82, which adjoins the first area 81, the first housing 8 is configured in the shape of a T in longitudinal section. To form the T shape, the first housing 8 has a neck 83 which, when the sensor unit 7 is installed, extends in the radial direction of the longitudinal axis 100 of the torque sensor unit and is adjoined by a transversely located web 84. The transversely located web 84 is plate-like and, when installed, rests on both sides, in each case on a projection 18 of the edge 121 of the second housing 12. Each projection has two contact surfaces 181, 182, which form a type of guide for the introduction of the sensor unit 7.

The second housing 12, the housing cover 13 and preferably the inner casing tube 14 are made of a magnetically conductive material for the magnetic shielding of the torque sensor unit 1. The magnetic shielding is ensured here by a suitable material selection of the corresponding components. Preferably, the components 12, 13, 14 are produced from a soft magnetic material with a high magnetic conductivity and a low coercivity field strength, in particular ferritic steel. With the aid of this shielding, it is possible to deflect the field lines of external magnetic fields around the torque sensor unit 1 and thus to suppress the influencing of the torque sensor by disruptive fields, wholly or at least to a considerable extent. The shielding is not provided to delimit the magnetic fields between the components of the torque sensor unit and the integral assembly. It protects the entire torque sensor unit from external influences.

1.-13. (canceled)

14. A torque sensor unit comprising:
a ring magnet that is connectable to a first partial shaft in a torque-proof manner;
a magnetic yoke that is connectable to a second partial shaft and that is disposed in a magnetic field originating from the ring magnet;
magnetic flux conductors that are connectable to the second partial shaft and that conduct magnetic fluxes generated by the magnetic yoke;
a sensor unit that includes a first housing, which detects a change in a rotational angle between the first and second partial shafts by measuring the magnetic flux density generated between the magnetic flux conductors; and
a second housing that surrounds the ring magnet, the magnetic yoke, the magnetic flux conductors, and the sensor unit, the second housing having a housing opening that is at least partly closed by a housing cover,
wherein the second housing and the housing cover are comprised of magnetically conductive material for magnetically shielding the torque sensor unit.

15. The torque sensor unit of claim 14 wherein the housing cover includes a cutout through which the first partial shaft passes when installed and in which an inner casing tube is received, wherein the inner casing tube is comprised of a magnetically conductive material for magnetically shielding the torque sensor unit.

16. The torque sensor unit of claim 15 wherein the inner casing tube is part of an adjustable steering column.

17. The torque sensor unit of claim 15 wherein the inner casing tube is welded to the housing cover.

18. The torque sensor unit of claim 14 wherein the magnetically conductive material comprises ferritic steel.

19. The torque sensor unit of claim 14 comprising a third magnetic flux conductor and a magnetic sensor disposed on a circuit board, wherein the third magnetic flux conductor, the magnetic sensor, and the circuit board are received in a first housing.

20. The torque sensor unit of claim 14 wherein the housing cover is fixed by screws to an outer wall of the second housing.

21. The torque sensor unit of claim 14 wherein the second housing includes a housing opening in an area of the sensor unit for at least one of a data line or a power supply.

22. The torque sensor unit of claim 14 wherein the sensor housing is fixed by screws to a base plate of the second housing.

23. The torque sensor unit of claim 22 comprising a flange for fixing the second housing to a transmission housing, wherein the second housing includes a housing opening in an area of the sensor unit for at least one of a data line or a power supply, wherein the flange is disposed on a side of the base plate of the second housing that is remote from the housing opening.

24. An electromechanical steering system for a motor vehicle, the electromechanical steering system comprising:
the torque sensor unit of claim 14;
a steering pinion that is connected to a second partial shaft and that is engaged with a rack for steering wheels, wherein the rack is mounted displaceably along a longitudinal axis in a third housing; and
an electric motor for steering force assistance,
wherein the torque sensor unit is disposed between a first partial shaft connected to a steering wheel and the second partial shaft and detects a torque introduced into the steering wheel by a driver.

25. The electromechanical steering system of claim 24 wherein a steering column comprising the first and second partial shafts is telescopic and includes an outer casing tube and an inner casing tube.

26. The electromechanical steering system of claim 25 wherein the electric motor is disposed on the steering column and introduces power steering assistance into a lower partial shaft by way of a transmission disposed in a transmission housing.
